(19) United States
(12) Patent Application Publication
(10) Pub. No.: US 2017/0126704 A1
(43) Pub. Date: May 4, 2017

(54) Method And Devices For Non-Intrusive Malware Detection For The Internet Of Things (IOT)

(71) Applicant: QUALCOMM Incorporated, San Diego, CA (US)

(72) Inventors: Sriram Nandha Premnath, San Jose, CA (US); Saumitra Mohan Das, Santa Clara, CA (US); Rajarshi Gupta, Sunnyvale, CA (US)

(21) Appl. No.: 14/924,763

(22) Filed: Oct. 28, 2015

(51) Int. Cl. H04L 29/06; G06F 21/56

(52) U.S. Cl. CPC H04L 63/145; G06F 21/56; G06F 21/567; G06F 2221/034

(57) ABSTRACT

Method and devices of detecting a malware infection of a computing device in a communication network are disclosed. A computing device may monitor outputs of temperature sensors associated with elements of the computing device. The monitored outputs of the temperature sensors may be compared to a profile of temperatures associated with normal operation of the computing device. A deviation of the monitored temperatures from the profile of temperatures associated with normal operation may be reported. The profile of temperatures associated with the normal operation of the computing device may be learned based on temperature sensor data obtained during normal operations. Learning the profile of temperatures may include monitoring outputs of temperature sensors associated with elements of the computing device during normal operation of the computing device and storing the monitored outputs as one or more profiles of temperatures associated with normal operation of the computing device.

### BACKGROUND

Facilitated by wide reach of network communications, malicious software (“malware”) has become an increasingly pervasive problem for computer systems including mobile communication devices, networked device. A particular concern is the risk of malware intrusion to devices connected in a personal network, such as the Internet of Things (IoT). Malware intrusions into IoT networks can allow malicious code to intrude into smart home systems and other systems having personal importance to individuals and families.

Malware is software that is used to gain access to or disrupt the operation of a computer or computer system, gather sensitive information including credit card numbers, bank account numbers, passwords, keystrokes, etc. with malicious intent. Generally, malware is surreptitiously installed and is intentionally configured to be harmful or disruptive to a computer system. Malware may become installed on a computing device through various means including media, communication channels, BIOS, etc. Malware is configured to be difficult to detect and remove and includes Trojan horses, viruses, spyware, adware, etc. Malware often appears in a system as innocuous and non-malicious files. Alternatively, malware may be hidden or located in portions of the file system that are rarely accessed by the ordinary user.

Although some solutions exist to mitigate malware intrusion, malware solutions are often too costly, ineffective or impractical. For example, many existing malware detection approaches are very intrusive. Software-based malware mitigation approaches require observation of application programming interface (API) calls at several layers in software stack such as the Android framework, operating system (OS) kernel, third party libraries, etc. Such observation can create unacceptable performance, such as increased latency, which interferes with application execution and computer operations. In particular operations involving real time or near real time processing may be adversely affected by software mitigation solutions that increase processing latency. Hardware-based malware mitigation approaches often require an external device to monitor power, may require a dedicated processing core to monitor other processing cores (e.g., such as in a System on Chip (SoC) environment). Other existing solutions involve matching various operations of a potentially infected computing device against known malware signatures, which is limited by the comprehensiveness of a malware signature database. Thus, existing solutions may require changes to software applications running on the device. Existing solutions may require hardware changes on devices to capture system usage effectively and may require frequent observations that are power inefficient and affect performance. Further, existing solutions may not be accurate and may report false positives.

### SUMMARY

Various embodiments include methods of detecting a malware infection of a computing device in a communication network that may include monitoring outputs of temperature sensors associated with elements of the computing device, comparing monitored output of the temperature sensors to a profile of temperatures associated with normal operation of the computing device, and reporting a deviation of the monitored output of the temperature sensors from the profile of temperatures associated with normal operation. Some embodiments may further include learning the profile of temperatures associated with the normal operation of the computing device based on temperature sensor data obtained during normal operations. In some embodiments, learning the profile of temperatures associated with the normal operation of the computing device based on temperature sensor data obtained during normal operations may include monitoring outputs of temperature sensors associated with elements of the computing device during normal operation of the computing device, and storing the monitored outputs of the temperature sensors associated with the elements of the computing device as one or more profiles temperatures associated with normal operation of the computing device. In some embodiments, the communication network may include an Internet of Things (IoT) and the computing device may be an IoT device.

Some embodiments may further include identifying one or more of the elements of the computing device responsible for the deviation of the monitored output of the temperature sensors from the profile of temperatures associated with normal operation.

In some embodiments, reporting the deviation may include reporting an indication of a malware infection of the computing device. Some embodiments may further include comparing the monitored outputs of the temperature sensors with a malware profile of temperatures associated with operations of the computing device indicative of a malware infection. The malware profile may be received from a source computing device via the network. Some embodiments may further include determining based on the comparison of whether the monitored outputs of the temperatures sensors match the malware profile, and reporting a malware infection in response to determining that the monitored outputs of the temperatures sensors match the malware profile.

In some embodiments, comparing monitored output of the temperature sensors to a profile of temperatures associated with normal operation of the computing device may include calculating at least one member of the group consisting of a mean, a variance, a skewness, a kurtosis, and an autocorrelation of the monitored output of the temperature sensors, and the profile of temperatures associated with normal operation of the computing device. In some embodiments, reporting a deviation of the monitored output of the temperature sensors from the profile of temperatures associated with normal operation may include reporting the deviation based on at least one member of the group consisting of the calculated mean, variance, skewness, kurtosis, and autocorrelation of the monitored output of the temperature sensors, and the profile of temperatures associated with normal operation of the computing device.

In some embodiments, reporting a deviation of the monitored output of the temperature sensors from the profile of temperatures associated with normal operation may include reporting the deviation to a hub of the communication network. Some embodiments may further include receiving, from the hub of the communication network, feedback indicating whether the reported deviation is a false positive indicative of a malware infection. In some embodiments, the received feedback may be based on information associated with the reported deviation collected by the hub from a plurality of devices coupled to the communication network. In some embodiments, the received feedback may be based on information associated with the reported deviation collected by the hub from a cloud server coupled to the communication network. In some embodiments, the received feedback may be based on information of a software upgrade for the computing device that affects at least one member of the group consisting of the monitored output of the temperature sensors, the profile of temperatures associated with normal operation of the computing device, and the reported deviation collected by the hub from a cloud server coupled to the communication network.

Further embodiments include a computing device having a plurality of temperature sensors associated with elements of the computing device, a transceiver configured to communicate with a communication network, a memory, and a processor coupled to the plurality of temperature sensors, the transceiver, and the memory. The processor is configured with processor-executable instructions to perform operations of the methods described above. Further embodiments include a non-transitory processor-readable storage medium having stored thereon processor-executable instructions configured to cause a processor of a computing device to perform operations of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the invention.

FIG. 1A is a diagram illustrating an example computing devices, a network hub, and a cloud server in a communication network suitable for use with various embodiments.

FIG. 1B is a block diagram illustrating components of an example computing device including a system-on-chip (SoC) suitable for use with various embodiments.

FIG. 1C is a graph illustrating the outputs of temperature sensors of elements of a computing device in accordance with various embodiments.

FIG. 2A is a diagram illustrating generating profiles for elements of a computing device in accordance with various embodiments.

FIG. 2B is a diagram illustrating generating task-specific profiles for elements of a computing device in accordance with various embodiments.

FIG. 2C is a diagram further illustrating generating task-specific profiles for elements of a computing device in accordance with various embodiments.

FIG. 2D is a functional block diagram illustrating comparing monitored sensor outputs with profile and task information for elements of a computing device in accordance with various embodiments.

FIG. 3A is a functional block diagram illustrating devices providing reports to and receiving feedback from a network hub in accordance with various embodiments.

FIG. 3B is a functional block diagram illustrating network hubs providing reports to and receiving feedback from a cloud server and other network hubs via the cloud in accordance with various embodiments.

FIG. 4 is a process flow diagram illustrating an embodiment method for detecting a malware infection including monitoring outputs of temperature sensors of elements of a computing device in accordance with various embodiments.

FIG. 5 is a process flow diagram further illustrating an embodiment method for comparing numeric embodiments of monitored outputs of temperature sensors of elements of a computing device and profiles, in accordance with various embodiments.

FIG. 6 is a process flow diagram illustrating an embodiment method for generating a temperature profile and task-based temperature profile in accordance with various embodiments.

FIG. 7 is a process flow diagram illustrating an embodiment method for receiving reports and other information in a computing device and providing feedback to an IoT device reporting a deviation in accordance with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “computing device” is used herein to refer to any one or all of Internet of things (IoT) devices, smart home devices, smart appliances, smart utility meters (gas, electric, etc.), smart parking meters, cellular telephones, smart phones, personal or mobile multi-media players, personal data assistants (PDA's), laptop computers, desktop computers, tablet computers, smart books, palm-top computers, wireless electronic mail receivers, multimedia Internet enabled cellular telephones, televisions, smart TVs, smart TV set-top buddy boxes, integrated smart TVs, streaming media players, smart cable boxes, set-top boxes, digital video recorders (DVR), digital media players, and similar personal electronic devices which include a programmable processor, especially those that include an SoC.

The various embodiments address and overcome the drawbacks of current malware by enabling non-intrusive malware detection. The various embodiments include monitoring the output of temperature sensors that may be incorporated into elements of a computing device. The monitored output of the temperature sensors may be compared to a profile of temperatures that reflect the normal operation of the computing device. The computing device may determine whether the monitored temperatures deviate from the temperature profile associated with normal operation. Deviations from the temperature profile may be reported via an IoT network, such as a notification of a malware infection or possible malware infection to a network computing device, such as an IoT hub. The hub may provide feedback indicating whether the deviation represents a false positive.

For example, in various embodiments, the hub may have access to reports from other devices, reports from other hubs connected through the cloud, information from a cloud server, etc. some or all of which may be used to validate the malware report. The reports and information collected by the hub may indicate that certain deviations should be expected. For example, the reports and information gathered by the IoT hub may indicate that local temperatures are high (or low). The high or low temperature may correspond with the deviation. In other words, the deviation may relate to abnormally high temperatures monitored by the computing device, and the information gathered by the hub may indicate that ambient temperatures are high. In such an instance, the IoT hub may generate feedback that indicates to the device reporting the malware infection that the deviation is likely a false positive. On the other hand the monitored high temperatures may correlate with frequent cycling of a particular element in a way that deviates from the normal profile. The IoT hub may have information from other devices indicating normal cycling. In such an instance, the IoT hub may generate an indication that the reported deviation is likely to be a malware infection. The various embodiments enable more accurate identification of deviations that actually indicate genuine malware infections and that are not false positive indications.

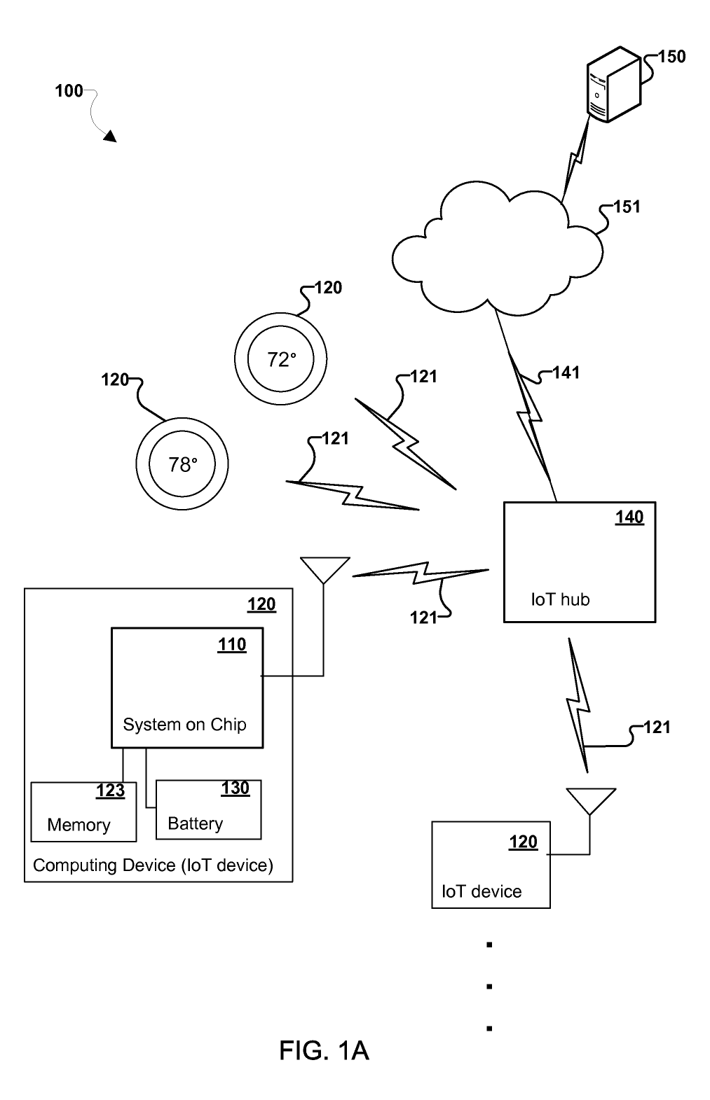

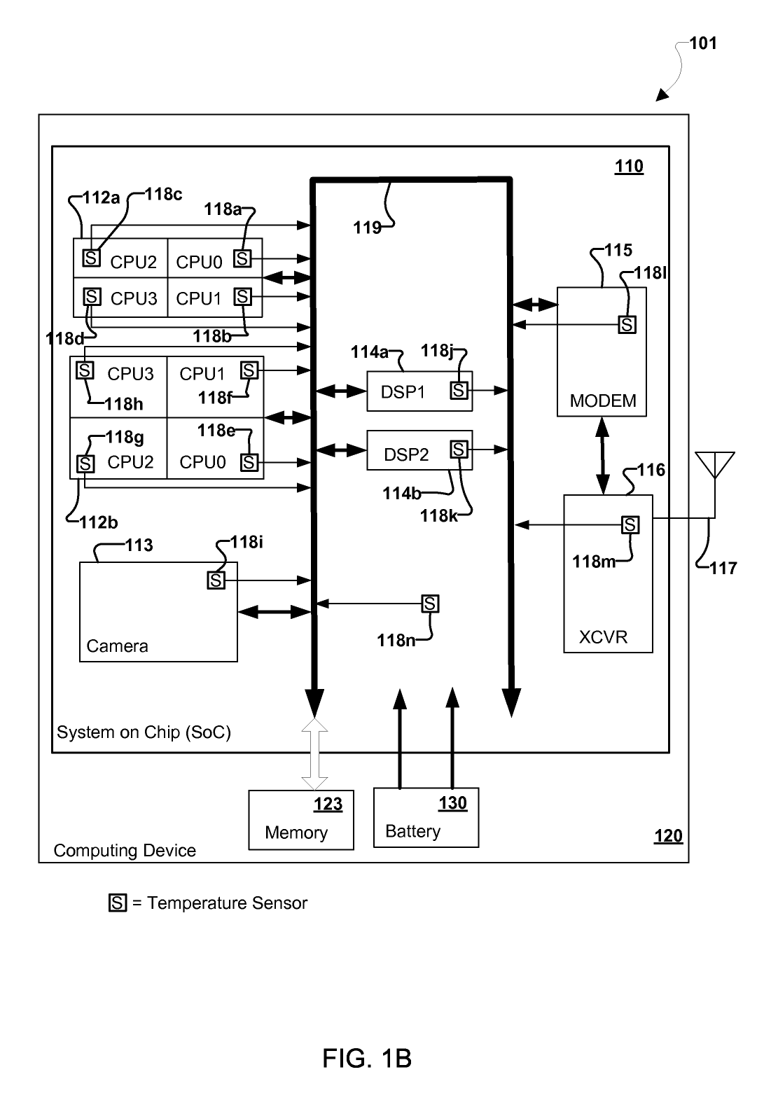

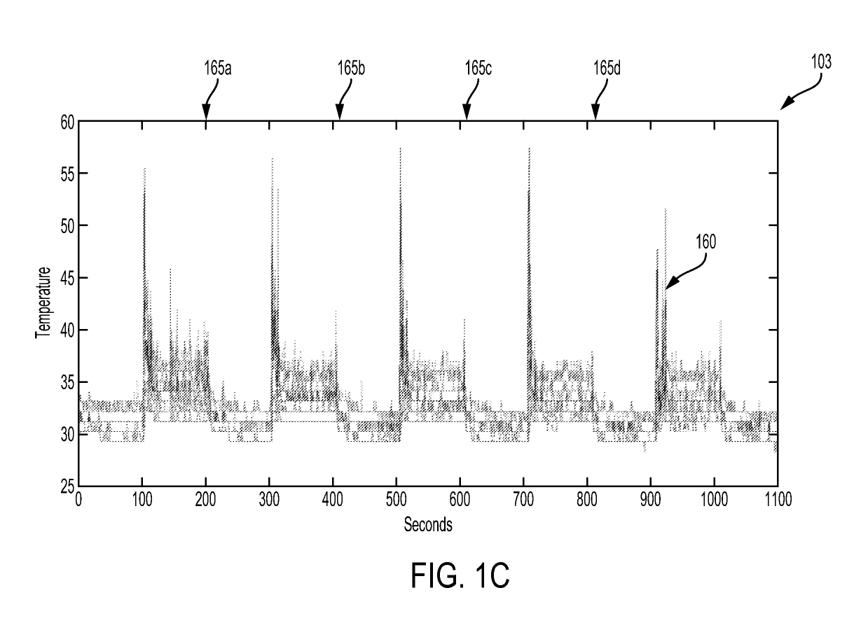

FIGS. 1A-1C illustrate various embodiments. FIG. 1A illustrates a network environment or a portion of a typical network environment 100, including an Internet of Things (IoT). The network environment 100 includes computing device 120, which can include IoT device. In an example embodiment, the computing devices 120 may be IoT devices that include elements of a smart home, such as thermostats, appliance controls, entertainment devices, and other devices. The network environment may also include a network hub 140 to which the computing devices 120 may connect through wireless connections 121. The network hub 140 may further connect to a public network such as the Internet or a cloud 151 through a connection 141, which may be a wired or wireless connection. The network hub 140 may have access to a cloud server 150 through the cloud connection. Each of the devices may contain elements such as a system on chip (SoC) 110, a memory 123 and a battery 130.

FIG. 1B illustrates an example 101 including further details of the SoC 110 of the computing device 120. Although in various embodiments, the computing device 120 includes the SoC 110, in some embodiments, the computing device 120 may not include a system on chip and instead may include system components that are not incorporated into a system on chip. Alternatively, the computing device 120 may include a system on chip and may also include additional component other than a system on chip.

The SoC 110 may include various elements such as a first central processing unit group 112a and a second central processing unit group 112b, a camera processor 113, a first digital signal processor (DSP) 114a, a second DSP 114b, a modem 115, and a transceiver 116 with an antenna 117. The elements of the SoC 110 may include a series of temperature sensors 118a-118m, an additional temperature sensor or sensors 118n may be provided for the SoC 110. The elements of the SoC 110 and the computing device 120 and the temperature sensors 118a-118n may be coupled to a bus 119 of the SoC 110. The bus 119 may be coupled externally to other elements of the computing device 120, such as the memory 123. Other support circuits of the SoC 110 are omitted from the drawings and description for brevity.

As the elements of the SoC 110 are in operation, such as the first central processing unit (CPU) group 112a and the second CPU group 112b, the camera processor 113, the first DSP 114a, the second DSP 114b, the modem 115, and the transceiver 116 with the antenna 117, the associated individual temperatures sensors 118a-118m may be used to determine the individual temperatures of the elements. The temperature sensors 118a-118n may be monitored through low level operating system services that result in the capability to monitor the output of the temperature sensors 118a-119n with very little processing overhead. For example, various embodiments may use mechanisms such as “sysfs” available in Linux operating systems. The sysfs mechanism may be provided by the Linux kernel. The sysfs mechanism exports information about various kernel subsystems, hardware devices, and associated device drivers to a user space that may be accessed by devices/applications through virtual files, which may be stored in hardware memory, such as the memory 123 of the computing device 120. Using existing functions associated with Thermal Management for observing temperature involves no overhead. Thus, using mechanisms such as sysfs, the output of the temperature sensors may be accessed as frequently as necessary to achieve a desired degree of resolution in temperature monitoring to identify potential malware.

FIG. 1C is a graph that illustrates an example of monitored temperature sensor outputs for elements of the computing device 120 over time. A trace 160 represents an example pattern of the temperature during operation of the computing device 120 and one or more elements of the SoC 110. The trace 160 may include repeating sections 165a-165d. Various embodiments may be particularly effective for IoT devices that have predictable repeating patterns of operations that can be monitored and otherwise observed.

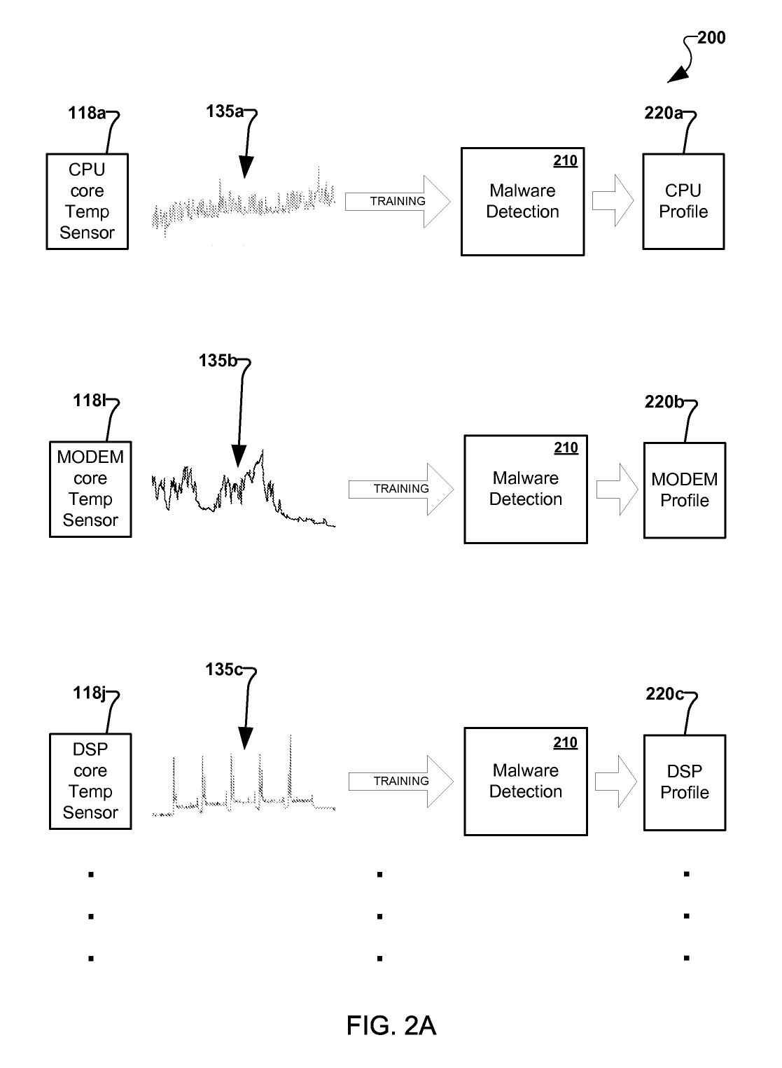

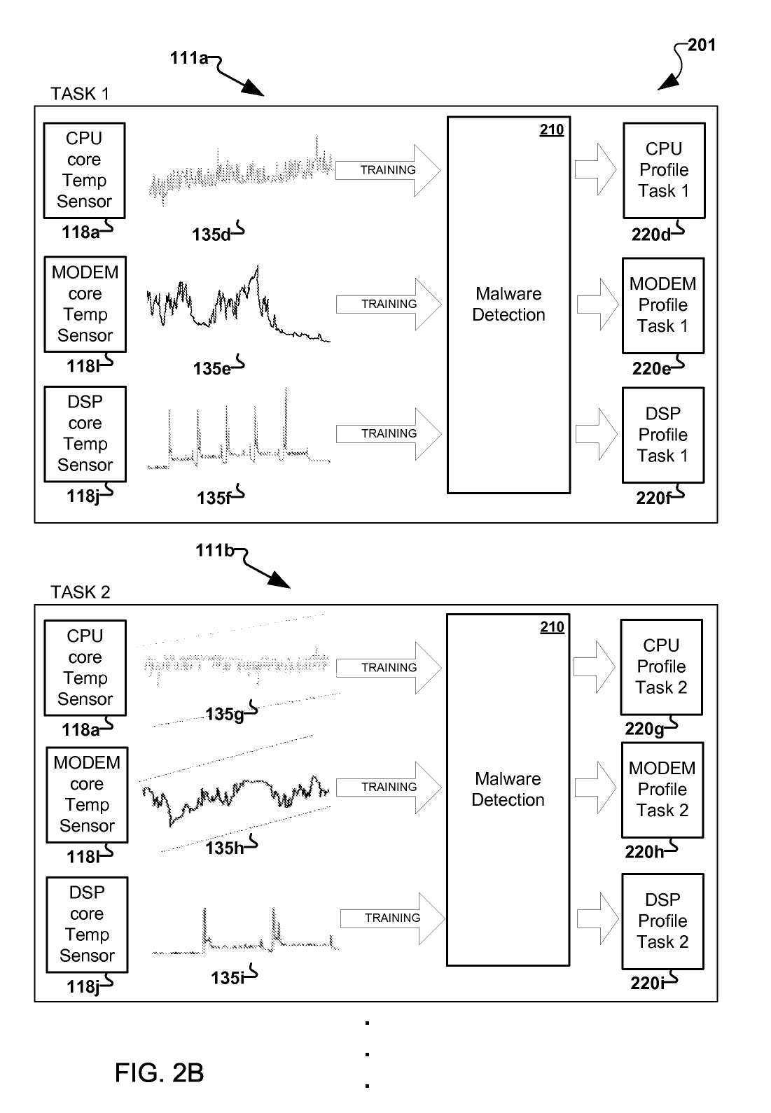

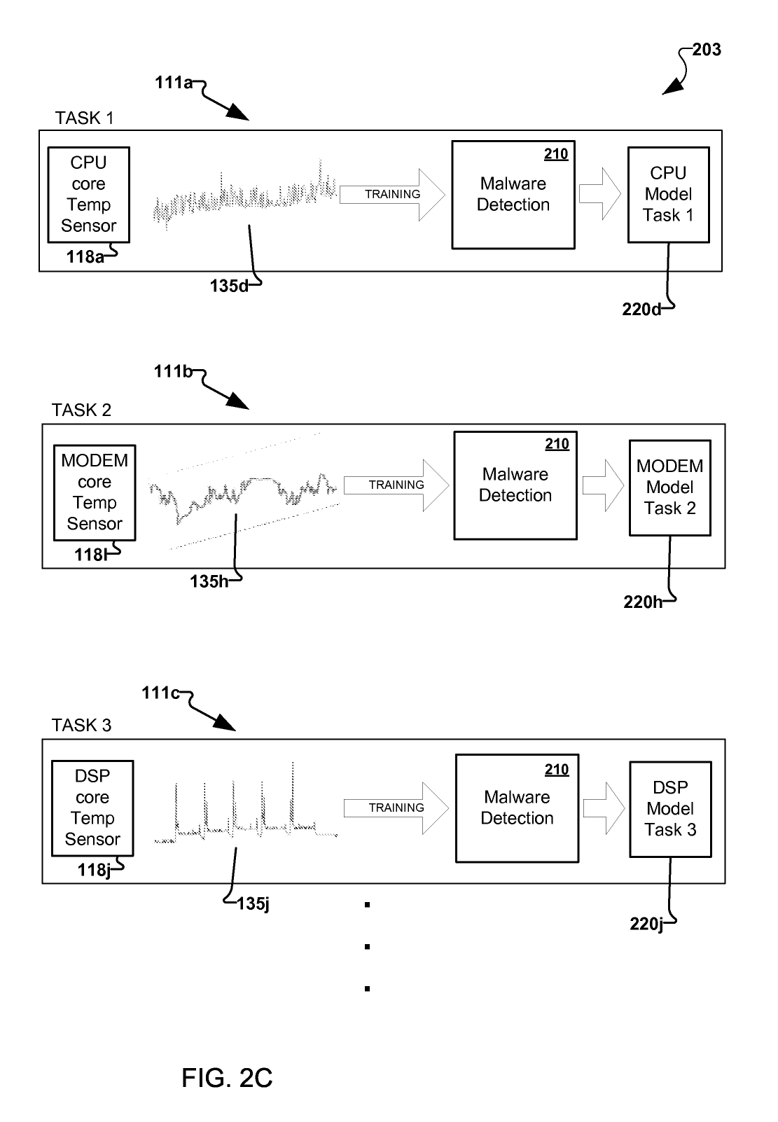

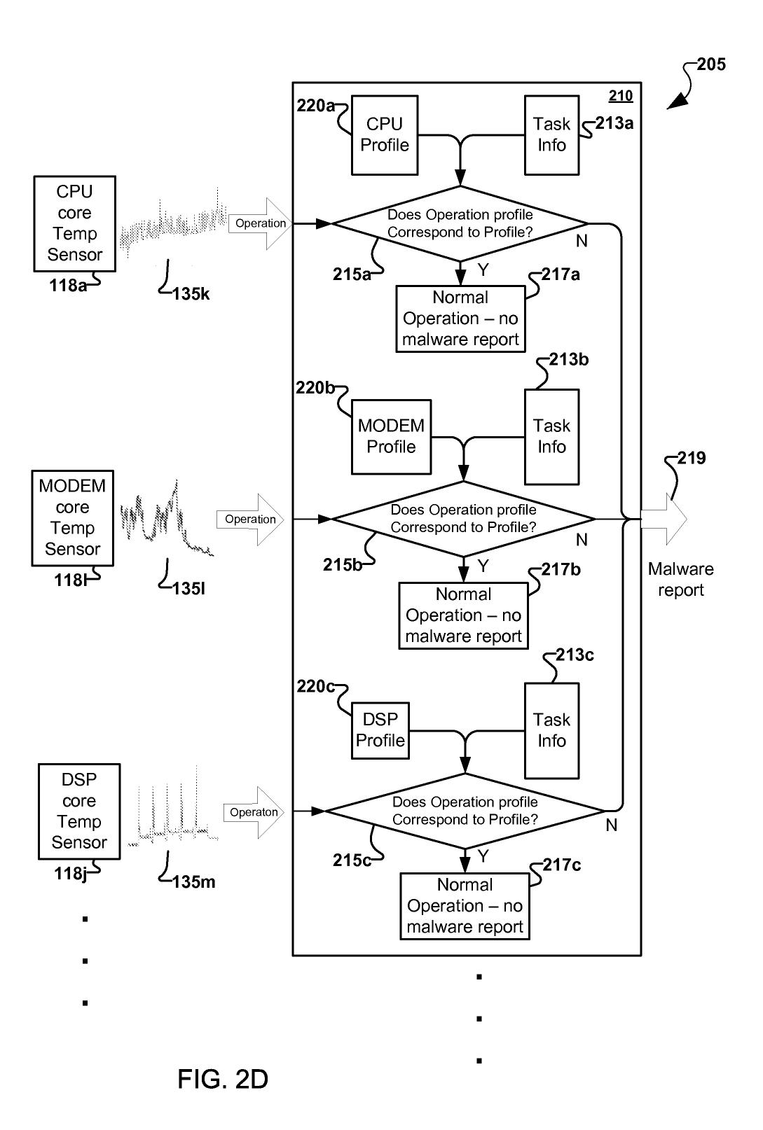

FIG. 2A illustrates an example 200 of generating profiles of various elements of the SoC 110 of the computing device 120, such as a CPU core, a MODEM core, and a DSP core. Profiles for other elements may also be generated in various embodiments. The CPU core temperature sensor 118a may generate temperature output data over time as a pattern 135a. The pattern 135a may be used for training a malware detection module 210 to generate a CPU profile 220a. The CPU profile 220a may represent the temperatures of the CPU core during normal operations.

Similarly, the MODEM core temperature sensor 118j may generate temperature output data over time as a pattern 135b. The pattern 135b may be used for training the malware detection module 210 to generate a MODEM profile 220b. The MODEM profile 220b may represent the temperatures of the MODEM core during normal operations.

The DSP core temperature sensor 118j may generate temperature output data over time as a pattern 135c. The pattern 135c may be used for training the malware detection module 210 to generate a DSP profile 220c. The DSP profile 220c may represent the temperatures of the DSP core during normal operations. The profiles, such as the CPU profile 220a, the MODEM profile 220b, and the DSP profile 220c, may be further refined to take into account joint operation, e.g. the effect of the operation of proximal elements.

FIG. 2B illustrates an example 201 of generating task-based profiles of various elements of the SoC 110 of the computing device 120, such as a CPU core, a MODEM core, and a DSP core. Profiles for other elements may also be generated in various embodiments. Though all temperature sensor outputs have some relation to a currently executing task or tasks, various embodiments may encompass temperature patterns that are associated with a specific task or tasks. The CPU core temperature sensor 118a may generate temperature output data over time as a pattern 135d associated with a first task 111a. The pattern 135d may be used for training the malware detection module 210 to generate a CPU profile 220d associated with the first task 111a. The CPU profile 220d may represent the temperatures of the CPU core during normal operations for the first task 111a.

Similarly, the MODEM core temperature sensor 118j may generate temperature output data over time as a pattern 135e associated with the first task 111a. The pattern 135e may be used for training the malware detection module 210 to generate a MODEM profile 220e associated with the first task 111a. The MODEM profile 220e may represent the temperatures of the MODEM core during normal operations associated with the first task 111a.

The DSP core temperature sensor 118j may generate temperature output data over time as a pattern 135f associated with the first task 111a. The pattern 135f may be used for training the malware detection module 210 to generate a DSP profile 220f associated with the first task 111a. The DSP profile 220f may represent the temperatures of the DSP core during normal operations associated with the first task 111a. The profiles, such as the CPU profile 220d, the MODEM profile 220e, and the DSP profile 220f, may be further refined to take into account joint operation, e.g. the effect of the operation of proximal elements.

For a second task 111b, the CPU core temperature sensor 118a may generate temperature output data over time as a pattern 135g associated with the second task 111b. The pattern 135g may be used for training the malware detection module 210 to generate a CPU profile 220g associated with the second task 111b. The CPU profile 220g may represent the temperatures of the CPU core during normal operations for the second task 111b.

Similarly, the MODEM core temperature sensor 118j may generate temperature output data over time as a pattern 135h associated with the second task 111b. The pattern 135h may be used for training the malware detection module 210 to generate a MODEM profile 220h associated with the second task 111b. The MODEM profile 220h may represent the temperatures of the MODEM core during normal operations associated with the second task 111b.

The DSP core temperature sensor 118j may generate temperature output data over time as a pattern 135i associated with the second task 111b. The pattern 135i may be used for training the malware detection module 210 to generate a DSP profile 220i associated with the second task 111b. The DSP profile 220i may represent the temperatures of the DSP core during normal operations associated with the second task 111b. The profiles 220g, 220h, and 220i may be further refined to take into account joint operation, e.g. the effect of the operation of proximal elements.

FIG. 2C illustrates an additional example 203 including the first task 111a, the second task 111b and a third task 111c, which are executed by different elements of the computing device 120. For example, the CPU core, the MODEM core and the DSP core. The CPU core temperature sensor 118a may generate temperature output data over time as a pattern 135d associated with the first task 111a. The pattern 135d may be used for training the malware detection module 210 to generate the CPU profile 220d associated with the first task 111a. The CPU profile 220d may represent the temperatures of the CPU core during normal operations for the first task 111a.

Similarly, the MODEM core temperature sensor 118l may generate temperature output data over time as a pattern 135h associated with the second task 111b. The pattern 135h may be used for training the malware detection module 210 to generate a MODEM profile 220h associated with the second task 111b. The MODEM profile 220h may represent the temperatures of the MODEM core during normal operations associated with the second task 111b.

The DSP core temperature sensor 118j may generate temperature output data over time as a pattern 135j associated with a third task 111c. The pattern 135j may be used for training the malware detection module 210 to generate a DSP profile 220j associated with the third task 111c. The DSP profile 220j may represent the temperatures of the DSP core during normal operations associated with the third task 111c. The profiles, such as the CPU profile 220d, the MODEM profile 220h, and the DSP profile 220j, may be further refined to take into account joint operation, e.g. the effect of the operation of proximal elements.

FIG. 2D illustrates an additional example 205 including the consideration of element profiles and task information when measuring the output of temperature sensors for the elements of the computing device 120 during operations. For example, the CPU core, the MODEM core and the DSP core. The CPU core temperature sensor 118a may generate temperature output data over time as a pattern 135k during operation. The pattern 135k may be input to the malware detection module 210. In determination block 215a, a processor of the computing device 120 may determine whether the pattern 135k corresponds to the CPU profile 220a including in consideration of task information 213a. In response to determining that the pattern 135k corresponds to the CPU profile 220a including in consideration of task information 213a (i.e., determination block 215a=“yes”), the processor may provide no malware report. In response to determining that the pattern 135k does not correspond to the CPU profile 220a including in consideration of task information 213a (i.e., determination block 215a=“no”), the processor may provide a malware report 219.

The MODEM core temperature sensor 118j may generate temperature output data over time as a pattern 135l during operation. The pattern 135l may be input to the malware detection module 210. In determination block 215b, the processor of the computing device 120 may determine whether the pattern 135l corresponds to the MODEM profile 220b including in consideration of task information 213b. In response to determining that the pattern 135l corresponds to the MODEM profile 220b including in consideration of task information 213b (i.e., determination block 215b=“yes”), the processor may provide no malware report. In response to determining that the pattern 135l does not correspond to the MODEM profile 220b including in consideration of task information 213b (i.e., determination block 215b=“no”), the processor may provide the malware report 219.

The DSP core temperature sensor 118j may generate temperature output data over time as a pattern 135m during operation. The pattern 135m may be input to the malware detection module 210. In determination block 215c, the processor of the computing device 120 may determine whether the pattern 135m corresponds to the DSP profile 220c including in consideration of task information 213c. In response to determining that the pattern 135m corresponds to the DSP profile 220c including in consideration of task information 213c (i.e., determination block 215c=“yes”), the processor may provide no malware report. In response to determining that the pattern 135m does not correspond to the DSP profile 220c including in consideration of task information 213c (i.e., determination block 215c=“no”), the processor may provide the malware report 219.

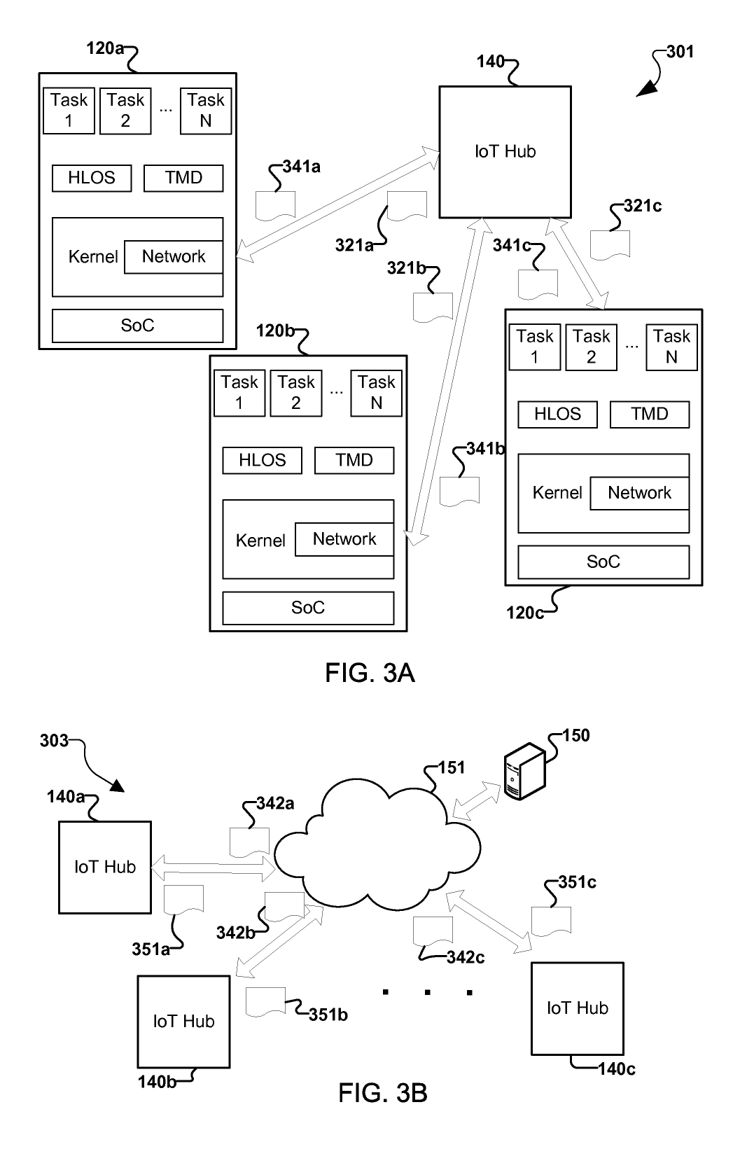

FIG. 3A illustrates an example 301 for providing reports to the IoT hub, such as the network hub 140. The computing devices 120a, 120b and 120c may be configured with various elements such as a high-level operating system (HLOS) (e.g., Android, etc.), a temperature based malware detection (TMD) module, an operating system kernel (e.g., Linux, etc.), a network interface (RF module) and a system on chip (SoC). Other devices that may ordinarily be present (e.g., power components, temperature sensors, etc.) are omitted for ease of description. The computing devices 120a, 120b and 120c may be coupled to the IoT hub 140 and provide respective malware reports 321a, 321b and 321c. The malware reports 321a, 321b and 321c may be provided as described herein when monitored temperatures associated with temperature sensors of one or more elements, such as elements of an SoC executing one or more of the tasks “Task 1,” “Task 2,” . . . “Task N” deviate from profiles representing normal operations. In response to receiving the malware reports 321a, 321b and 321c, the IoT hub 140 may analyze the reports and other information such as information available from the cloud, including other IoT hubs (and IoT devices) and/or cloud servers to determine if any information supports or contradicts the malware reports 321a, 321b and 321c. The IoT hub 140 may generate feedback reports 341a, 341b and 341c. The feedback reports 341a, 341b and 341c may contain an indication that the reported deviations of the malware reports 321a, 321b and 321c are false positives. Alternatively, the feedback reports 341a, 341b, and 341c may contain confirmations that the reported deviations of the malware reports 321a, 321b, and 321c are actual malware intrusions. In some embodiments, the computing devices 120a, 120b and 120c may be configured to identify one or more of the elements of the respective computing device that are associated with the reported deviations. In other words, in some embodiments, the elements responsible for the temperature anomalies may be “pinpointed” such that the source of the possible malware infection may be identified.

FIG. 3B illustrates an example 303 for providing reports from IoT hubs 140a, 140b and 140c to the cloud server 150 through the cloud 151. The IoT hubs 140a, 140b and 140c may be coupled to the cloud server 150 and provide respective reports 342a, 342b and 342c. The reports 342a, 342b and 342c may provide summaries of information received from devices coupled to the respective IoT hubs 140a, 140b and 140c. In response to receiving the reports 342a, 342b and 342c the cloud server 150 may process the reports, such as by analyzing, storing, comparing, or other processes and may consider additional information such as information available from the cloud, including other IoT hubs (and IoT devices), manufacture data, and/or other cloud servers to determine if any trends may be identified or other conclusions drawn about the information. Information gathered by the cloud server 150, may enable the resolution of legitimate wide-area temperature differences that could simultaneously affect a large number of IoT devices due to software upgrades or other wide-area phenomena. The information may be used by the cloud server 150 to generate feedback reports 351a, 351b and 351c. The feedback reports 351a, 351b, and 351c may contain information that may assist the IoT hubs 140a, 140b, and 140c in providing indications to their respective IoT devices, such as that reported deviations of malware reports are false positives or to confirm that reported deviations of malware reports are actual malware intrusions.

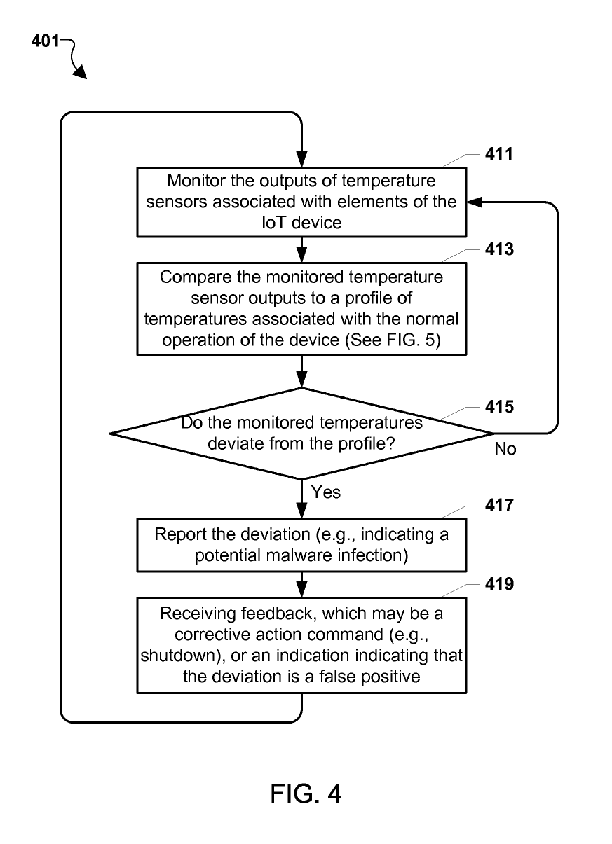

FIG. 4 illustrates a method 401 for detecting anomalous behavior, such as malware, in an IoT device by monitoring temperature sensors within the device according to various embodiments. The method 401 may be executed by a processor within the IoT device (e.g., processors such as the first and second CPU groups 112a or 112b illustrated in FIG. 1B).

In block 411, the processor may monitor outputs of the various temperature sensors associated with elements within the IoT device. As described, the IoT device may include several temperature sensors distributed throughout the device and associated with various elements. Data from each of these temperature sensors may be gathered periodically by the processor in block 411. The time that each temperature sensor is read may be stored so that the change in temperature over time can be used to recognize patterns consistent with normal behavior, abnormal behavior, or non-benign behavior.

The temperature sensor output data that is gathered in block 411 may be the raw output of the temperature sensor, such as a measured resistance from a thermistor. Thus, the temperature sensor output data need not be in units of temperature. However, in some embodiments, the processor may perform calculations on the temperature sensor output data in order to convert the data into temperature units.

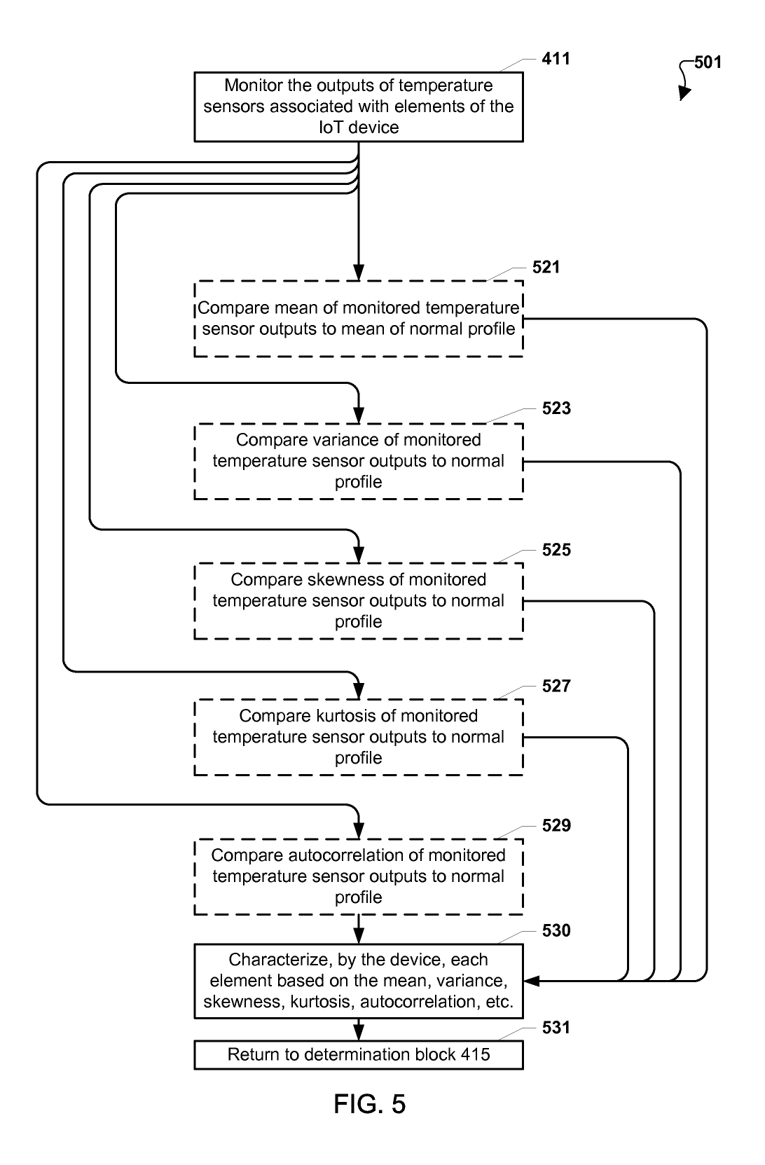

In block 413, the processor may compare the temperature sensor information obtained in block 411 to one or more profiles of temperatures versus time associated with normal operation of the IoT device. This comparison may involve any of a number of different types of statistical or mathematical data comparisons that will yield information regarding whether the observed temperature data is consistent with normal operations. Examples of data comparisons that may be accomplished in block 413 are described in more detail with reference to FIG. 5.

In comparing temperature sensor data to a temperature profile associated with normal operation, the processor may evaluate various groups of temperature sensors against one another and against the profile. For example, if all temperature sensors are showing the same rise in temperature over time, this may indicate nothing more than a rise in ambient temperature. In contrast, if the modem temperature is showing rapid increases followed by periodic decreases that are inconsistent with a temperature profile of normal operation for the processors, this difference in temperature changes over time may indicate anomalous behavior, such as the modem is being used to export data. Thus, the comparison of monitored temperature sensor data to temperature profiles may involve a variety of cross correlations among sensors as well as time-based trends.

As described above, the comparison of monitored temperature sensor data to normal operation temperature profiles may enable changes in temperature over relatively short durations, such as several milliseconds, to be evaluated. Also, the gathering of temperature data and comparison of that data to normal operating temperature profiles may be performed periodically, such as once a second, once a minute, etc. The granularity of temperature measurements used in the comparisons and the periodicity of such comparisons may be set so that anomalous behaviors can be recognized early.

In some embodiments, monitored temperature sensor data may be compared to a profile of temperatures associated with normal operations on a continuous or near continuous basis. In such embodiments, as each or groups of temperature sensor data are obtained, such data may be promptly compared to a normal operation temperature profile. In such continuous comparison embodiments, deviations from normal operation may be detected once a sufficient number of data points inconsistent with the normal operation temperature profile have been detected.

In determination block 415, the processor may determine whether the monitored temperature sensor data deviates from the profile of temperatures associated with normal operation. This determination may involve testing a calculated deviation between the monitored temperature sensor data and the temperature profile and comparing that deviation to a threshold. This determination may also include determining whether a number of deviations exceeding that threshold are observed within a monitoring period of time that exceeds a second threshold. Thus, the determination made in determination block 415 may account for noise in sensor data by requiring an affirmative determination to be based upon one, two or more thresholds must be exceeded.

So long as the monitored temperature sensor data remains within the normal operation temperature profile, the processor may take no action, and may continue to monitor the temperature sensor outputs in block 411.

In response to determining that the monitored temperatures deviate from the normal operation temperature profile (i.e. determination block 415=“yes”), the processor may report the deviation via the communication network in block 417. The form of this report may vary according to different embodiments and implementations. In some embodiments, the report may merely be a download of the temperature sensor data via the communication network to another computing device (e.g., a remote server) that may be configured to perform analysis on the data. In some embodiments, the report issued by the IoT device may be an alert of indicating the potential of a malware infection. Such reports may be transmitted to an IoT hub for relay to a control computer and/or other IoT devices in the communication network.

In some embodiments, a computing device coupled to the IoT communication network (e.g., a remote server or an IoT hub device) may reply to a report providing some feedback. In some embodiments, a reply from received from the IoT communication network in block 419 may be a command to perform a corrective action, such as shutting down, rebooting, etc. In some embodiments, the feedback received via the communication network may be an indication that the deviation is a false positive. In such embodiments, when a false positive feedback is received, the IoT device may adjust the thresholds used in determination block 415 for recognizing a temperature deviation that should be reported. In some embodiments, a feedback indicating that a reported deviation is a false positive may be used in learning algorithms to adjust the profile of temperatures associated with the normal operation of the IoT device.

In some embodiments, the operations in the method 401 may be performed in a continuous loop, such as part of a main operating loop sequence. In some embodiments, the operations of the method 401 may be performed periodically, such as hourly, daily, etc.

FIG. 5 illustrates a method 501 and includes various operations that may be used for performing the comparisons of monitored temperature sensor data to temperature profiles in block 413. The example operations illustrated in FIG. 5 are only some of the types of comparison operations that may be performed, and are not intended to be limiting.

In some embodiments, the temperature sensor data obtained in block 411 may be compared to the normal operating temperature profile based on averages or means in block 521. In such embodiments, the processor may calculate a mean of the monitored temperature sensor data and compare that to a mean of the temperature profile of associated with normal operation. In some embodiments, this comparison may involve computing the root mean squared difference between the monitored temperature sensor data and the normal temperature profile. In some embodiments, this comparison may involve determining the difference between monitored temperature sensor data and the root mean squared value of the normal operating temperatures. Such comparisons may also involve determining whether the difference between the monitored temperature sensor data and the normal profile exceeds a statistical measure of significance, such as one, two, or more standard deviations.

In some embodiments, the temperature sensor data obtained in block 411 may be compared to the normal operating temperature profile by calculating the variance between the sensor data and the normal operating temperature profile in block 523. Such comparisons may include determining a maximum variance and a minimum variance from the normal operating temperature profile. For example, a variance that exceeds a maximum normal operating temperature profile may be more significant for recognizing abnormal behavior than a variance from the minimum normal operating temperature profile as temperatures increase with component activity. In some embodiments, the calculated variance may be compared to a threshold value (or multiple thresholds depending upon the individual temperature sensors) in order to determine whether a reportable deviation is detected.

In some embodiments, the temperature sensor data obtained in block 411 may be analyzed to calculate the skew between the monitored temperature sensor data and the normal operating temperature profile in block 525. For example, in some embodiments this calculation may involve determining the interquartile range (IQR). In some embodiments, the calculated skewness of the monitored temperature sensor data may be compared to a threshold (or multiple thresholds) in order to determine whether a reportable deviation is detected.

In some embodiments, the temperature sensor data obtained in block 411 may be analyzed to comparing a kurtosis between the monitored temperature sensor data and the normal operating temperature profile in block 527. Such a comparison may evaluate and compare frequency domain features. In some embodiments, the kurtosis of the monitored temperature sensor data may be compared to a threshold (or multiple thresholds) in order to determine whether a reportable deviation is detected.

In some embodiments, the temperature sensor data obtained in block 411 may involve calculating an autocorrelation in the monitored temperature sensor data, and comparing the calculated autocorrelation with an autocorrelation associated with the normal operating temperature profile in block 529. For example, the more closely the monitored temperature sensor data is correlated with the normal operating temperature profile, the more likely the temperature data indicates normal operation. Similarly, the less well correlated that the monitored temperature sensor data is to the normal operating temperature profile, the more likely the temperature data indicates a deviation that should be reported. In some embodiments, the autocorrelation values of the monitored temperature sensor data and the normal operating temperature profile may be compared to determine whether the differences in autocorrelation values are within a threshold (or multiple thresholds) in order to determine whether a reportable deviation has been detected.

In some embodiments, regardless of how the comparisons between the monitor temperature sensor data and normal temperature profiles are calculated in blocks 521 through 529, the processor may characterize each element or groups of elements within the IoT device based on the comparisons in block 530. Such characterizations may involve cross correlations between various temperature sensors. For example, two or more distinct elements exhibiting similar (or dissimilar) temperature profiles that are inconsistent with a normal temperature profile may be indicative of a particular type of abnormal behavior (e.g., non-benign behavior) based upon the interoperations of the different elements. The results of such characterization of IoT device elements and data comparisons to normal operating profiles may be used in determination block 415 as described above. In other embodiments, the quantities such as mean, variance, skewness, kurtosis from blocks 521 through 529 may be monitored or calculated, stored and used by the processor to characterize the individual temperature sensors/elemements of the computing device, such as during training. For example, individual characterizations of the elements, such as during normal operation, may be used in establishing the normal operating profiles or in establishing individual characterization profiles for the temperature sensors/elements.

In some circumstances, the monitored temperature of an SoC component that is not in use may exhibit some variations due to the proximity of the SoC component to other components that are in use. Thus, in some embodiments, temperature based malware detection (TMD) may be configured to learn the correlation between adjacent components and accurately determine actual usage of each SoC component through joint observation and analysis. Accordingly, features that may be used for determining actual usage using joint observation and analysis of different sensors may include a proximity or separation distance between components, a correlation coefficient between components, and mutual information that is obtained and/or compiled regarding the components. The results of joint observation characterization of IoT device elements may be used to refine data comparisons to normal operating profiles and may be used in determination block 415 as described above.

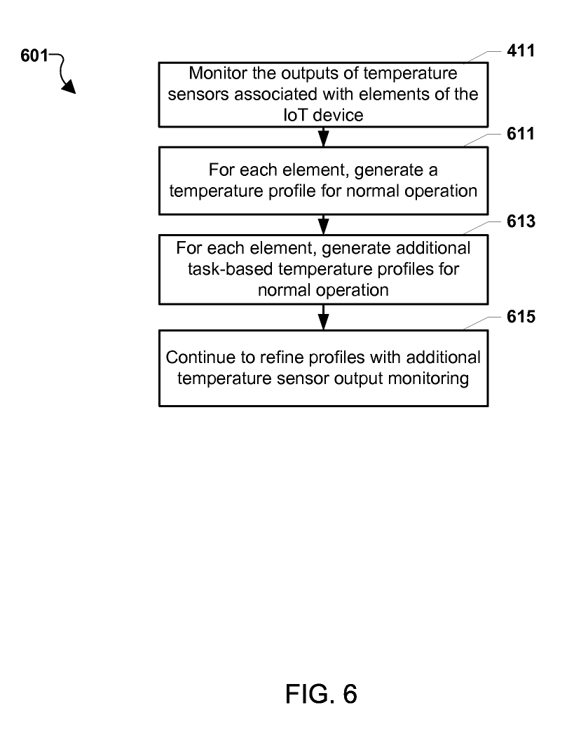

FIG. 6 illustrates a method 601 that may be implemented by a processor of an IoT device to develop (e.g., “learn”) a normal operating temperature profile for the IoT device according to various embodiments.

In block 411, the processor may monitor the outputs of temperature sensors associated with various elements of the IoT device as described above with reference to FIG. 4. In block 611, the processor may store the temperate sensor data on the basis of (i.e. correlated to) time and element. Gathering temperature sensor data as a function of time may enable the processor to develop a profile that characterizes changes in temperature over time during normal operations. Gathering the temperature sensor data for each instrumented element may enable the processor to recognize patterns or generate normal operating temperature profiles for each element and groups of elements. The operations involved in generating a temperature profile in block 611 may include normalizing data, statistically analyzing the data to determine an average or mean profile as well as standard deviations from such profiles, and performing other analyses to generate a profile that characterizes the data in a compact format. In other words, instead of storing all temperature sensor data for all elements at all times, processor may analyze each temperature sensor datum as received in order to update the normal operating temperature profile for the respective element.

In block 613, the processor may also generate additional task-based temperature from profiles for each element during normal operations. For example, the processor may note the current activity of the IoT device and calculate a normal operating temperature profile associated with that activity. For example, if the IoT device is in a low activity state, such as between periodic operations, the processor may generate a temperature profile characterizing normal temperature sensor data for each element in this low activity states. As another example, when the IoT device is performing a periodic high activity that involves significant processing or communicating via the transceiver, the processor may generate a normal operating temperature profile consistent with that high activity states. Thus, multiple normal operating temperature profiles may be generated, and each may be correlated to a particular activity of the IoT device.

This process of using the temperature sensor data to generate normal operating temperature profiles for various activities may be performed on a continuous or near continuous basis so that the normal temperature profiles a continue to be refined in block 615 as more temperature sensor data is obtained. Such operations may enable the IoT device to accommodate normal changes in temperature profiles that occur as the device ages or as ambient temperatures change gradually over time, such as seasonally.

The normal operating temperature profiles generated in block 611 and 613 may be stored in the memory of the IoT device. Thus, the learning algorithms involved in the method 601 may enable the IoT device to auto-generate its own temperature-based behavior monitoring profiles without the need for such profiles to be provided to the device. Additionally, the ability to continue to refine normal operating temperature profiles (e.g., in block 615) may enable the IoT device to refine default normal operating temperature profiles that are preloaded into the device memory during manufacture or set up.

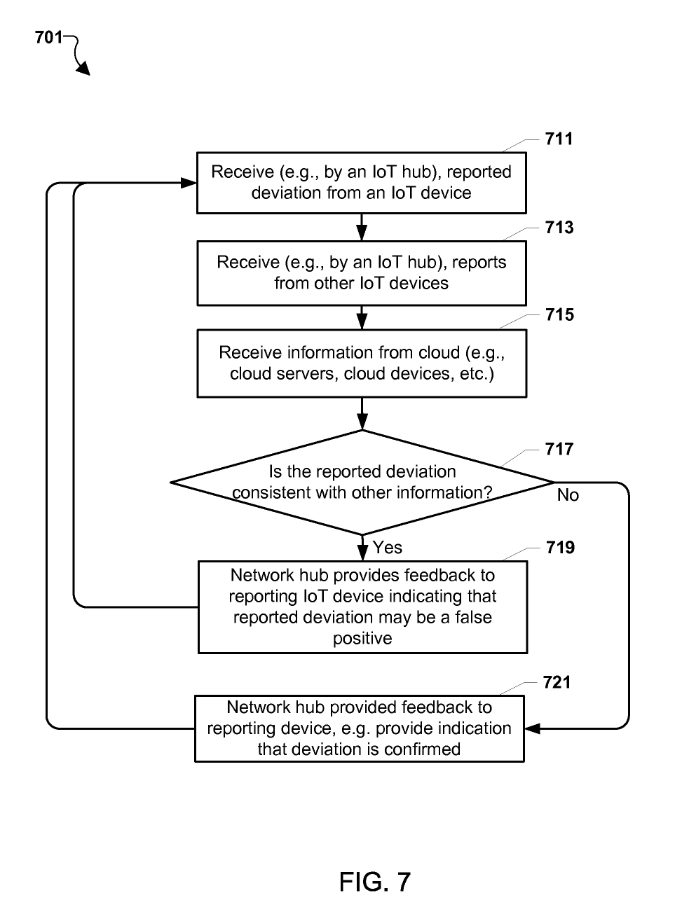

FIG. 7 illustrates a method 701 that may be implemented by a computing device or network hub within or coupled to an IoT communication network for receiving and responding to deviation reports received from IoT devices according to various embodiments. In block 711, a computing device (e.g., an IoT hub) may receive the deviation report generated from an IoT device, such as a deviation report generated in block 417 of the method 401 described with reference to FIG. 4.

In block 713, the computing device (e.g., an IoT hub) may receive deviation reports from other IoT devices within the IoT communication network, as well as IoT devices outside the network (e.g., reporting via the Internet).

In block 715, the computing device (e.g., an IoT hub) may access other sources of information, particularly information related to temperature, such as via the cloud or the Internet. In these operations, the computing device may access cloud servers that can provide local weather information, such as temperature and humidity, and access thermostats or ambient temperature sensors in the vicinity of the reporting IoT device. For example, the computing device (e.g., an IoT hub) may access a thermostat in the vicinity of the reporting IoT device to obtain the local ambient temperature. In some embodiments, the cloud servers may have access to information indicating that a software upgrade has been distributed to IoT devices within a given area associated with the deviation report or reports. The software upgrade may be responsible for reported deviations in temperature profiles. Therefore, the information regarding the software upgrade may be indicative of a false positive with regard to the reported deviation. In some embodiments, representative profiles known to be associated with the software upgrade may also be available from cloud servers and may be included in feedback reports. For example, IoT devices that have installed the software update may report deviations that include the deviant profile data. The deviant profile data may be provided by cloud servers to IoT devices or IoT hubs reporting deviations. Alternatively or additionally, the cloud servers may provide with the software upgrade information or representative profiles associated with the software upgrade.

In determination block 717, the computing device (e.g., an IoT hub) may analyze the report received from the reporting IoT device in the context of reports received from other IoT devices and relevant information obtained from other information sources in order to assess whether the reported deviation may be a false positive. For example, the computing device may determine whether the reported deviation is consistent with the other information obtained from other IoT devices and other information sources. In other words, the computing device may determine whether the reported deviation can be explained on the basis of observed ambient conditions (e.g., local high temperatures) or consistent reports by other IoT devices. This determination may enable the computing device to recognize reports that are likely to be false positives, as well as recognize reported deviations that warrant protective actions or further investigation.

In response to determining that the reported deviation is consistent with other information (i.e., determination block 717=“yes”), the computing device may provide feedback to the reporting IoT device indicating that the reported deviation may be a false positive in block 719. Such a report may include additional data, such as a reason for the determination in a format that may be used by the processor of the IoT device to improve or refine its normal operating temperature profile.

In response to determining that the reported deviation is not consistent with other sources of information (i.e. determination block 717=“no”), the processor computing device may provide feedback to the reporting device, such as providing corrective action commands or indicating that the deviation is confirmed in block 721.

Thus, various embodiments enable non-intrusive malware monitoring, detection, reporting, confirmation, etc. that has minimal or no impact on device operation and performance. In various embodiments, no changes are required to: 1) the applications running on the IoT device; 2) the software stack (e.g., Android framework, kernel, 3^{rd} party libraries, etc.); and 3) the device hardware.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the,” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of detecting a malware infection of a computing device in a communication network, comprising:
monitoring, by the computing device, outputs of temperature sensors associated with elements of the computing device;
comparing, by the computing device, the monitored outputs of the temperature sensors to a profile of temperatures associated with normal operation of the computing device; and
reporting, by the computing device, a deviation of the monitored outputs of the temperature sensors from the profile of temperatures associated with normal operation.

2. The method according to claim 1, further comprising learning, by the computing device, the profile of temperatures associated with the normal operation of the computing device based on temperature sensor data obtained during normal operations.

3. The method according to claim 1, wherein the profile of temperatures associated with normal operation of the computing device comprises a learned temperature profile.

4. The method according to claim 2, wherein learning the profile of temperatures associated with the normal operation of the computing device based on temperature sensor data obtained during normal operations comprises:
monitoring, by the computing device, outputs of temperature sensors associated with elements of the computing device during normal operation of the computing device; and
storing the monitored outputs of the temperature sensors associated with the elements of the computing device as one or more profiles of temperatures associated with normal operation of the computing device.

5. The method according to claim 1, further comprising identifying, by the computing device, one or more of the elements of the computing device responsible for the deviation of the monitored outputs of the temperature sensors from the profile of temperatures associated with normal operation.

6. The method according to claim 1, wherein reporting the deviation comprises reporting an indication of a malware infection of the computing device.

7. The method according to claim 1, further comprising:
comparing, by the computing device, the monitored outputs of the temperature sensors to a malware profile of temperatures associated with operations of the computing device indicative of a malware infection, wherein the malware profile is received from a source computing device via the communication network;
determining, by the computing device based on the comparison, whether the monitored outputs of the temperatures sensors match the malware profile; and
reporting, by the computing device, a malware infection in response to determining that the monitored outputs of the temperatures sensors match the malware profile.

8. The method according to claim 1, wherein comparing, by the computing device, monitored outputs of the temperature sensors to a profile of temperatures associated with normal operation of the computing device comprises calculating at least one member of the group consisting of a mean, a variance, a skewness, a kurtosis, and an autocorrelation of the monitored outputs of the temperature sensors and the profile of temperatures associated with normal operation of the computing device.

9. The method according to claim 8, wherein reporting, by the computing device, a deviation of the monitored outputs of the temperature sensors from the profile of temperatures associated with normal operation comprises reporting the deviation based on the calculated at least one member of the group consisting of: the mean, the variance, the skewness, the kurtosis, and the autocorrelation of the monitored outputs of the temperature sensors and the profile of temperatures associated with normal operation of the computing device.

10. The method according to claim 1, wherein reporting a deviation of the monitored outputs of the temperature sensors from the profile of temperatures associated with normal operation comprises reporting, by the computing device, the deviation to a hub of the communication network.

11. The method according to claim 10, further comprising:
receiving, from the hub of the communication network, feedback indicating whether the reported deviation is a false positive indication of the malware infection.

12. The method according to claim 11, wherein the received feedback is based on information associated with the reported deviation collected by the hub from a plurality of devices coupled to the communication network.

13. The method according to claim 11, wherein the received feedback is based on information associated with the reported deviation collected by the hub from a cloud server coupled to the communication network.

14. The method according to claim 11, wherein the received feedback is based on information of a software upgrade for the computing device that affects at least one of the monitored outputs of the temperature sensors, the profile of temperatures associated with normal operation of the computing device, and the reported deviation collected by the hub from a cloud server coupled to the communication network.

15. The method according to claim 1, wherein the communication network comprises an Internet of Things (IoT) and the computing device comprises an IoT device.

16. A computing device, comprising:
a plurality of temperature sensors associated with elements of the computing device;
a transceiver configured to communicate with a communication network;
a memory; and
a processor coupled to the plurality of temperature sensors, the transceiver, and the memory, wherein the processor is configured with processor-executable instructions to perform operations comprising:
monitoring outputs of the plurality of temperature sensors;
comparing the monitored outputs of the temperature sensors to a profile of temperatures associated with normal operation of the computing device; and
reporting a deviation of the monitored output of the temperature sensors from the profile of temperatures associated with normal operation.

17. The computing device according to claim 16, wherein the processor is configured with processor-executable instructions to perform operations further comprising learning the profile of temperatures associated with the normal operation of the computing device based on temperature sensor data obtained during normal operations.

18. The computing device according to claim 16, wherein the processor is configured with processor-executable instructions to perform operations such that the profile of temperatures associated with normal operation of the computing device comprises a learned temperature profile.

19. The computing device according to claim 17, wherein the processor is configured with processor-executable instructions to perform operations such that learning the profile of temperatures associated with the normal operation of the computing device based on temperature sensor data obtained during normal operations comprises:
monitoring outputs of temperature sensors associated with elements of the computing device during normal operation of the computing device; and
storing the monitored outputs of the temperature sensors associated with the elements of the computing device as one or more profiles of temperatures associated with normal operation of the computing device.

20. A non-transitory processor-readable storage medium having stored thereon processor-executable instructions configured to cause a processor of a computing device to perform operations comprising:
monitoring outputs of temperature sensors associated with elements of the computing device;
comparing the monitored outputs of the temperature sensors to a profile of temperatures associated with normal operation of the computing device; and
reporting a deviation of the monitored outputs of the temperature sensors from the profile of temperatures associated with normal operation.
